(19) United States
(12) Patent Application Publication
(10) Pub. No.: US 2018/0077169 A1
(43) Pub. Date: Mar. 15, 2018

(54) Reflective Network Device Position Identification

(71) Applicant: Rapid Focus Security, LLC, Burlington, VT (US)

(72) Inventor: Sam Stelfox, Burlington, VT (US)

(73) Assignee: Rapid Focus Security, LLC, Burlington, VT (US)

(21) Appl. No.: 15/265,368

(22) Filed: Sep. 14, 2016

(51) Int. Cl. H04L 29/06

(52) U.S. Cl. CPC H04L 63/107; H04L 63/102

(57) ABSTRACT

A method of identifying a device positioned in a network and making domain assignments includes instantiating a network comprising an offsite server and a plurality of trusted devices positioned in at least two different domains. A plurality of local network graphs is generated for at least some of the plurality of trusted devices positioned in the at least two different domains. At least some of the plurality of local network graphs is transmitted to the offsite server. A probability that at least some of the plurality of trusted devices is positioned in the same domain is determined from the plurality of local network graphs. Trusted devices are assigned to domains based upon the determined probabilities. Domain assignments are updated for at least some of the plurality of trusted devices based upon the assignments of trusted devices to the domains.

The section headings used herein are for organizational purposes only and should not be construed as limiting the subject matter described in the present application in any way.

### INTRODUCTION

The growing number of wireless and wired network devices worldwide has generated a need for methods and apparatus that identify and characterize both trusted and untrusted devices quickly and efficiently. These trusted and untrusted devices include network nodes and processing devices. Networks of trusted devices, which can be located and operate across various combinations of private and public networks, can be managed and instructed by a trusted server, or a set of trusted servers, in order to perform a variety of coordinated and distributed tasks. One of many important tasks conducted by these distributed networks of trusted devices is the detection, review, and identification of rogue, misconfigured, and unauthorized devices across wired and wireless spectrums that are used by the various trusted and untrusted devices on the various networks. Other tasks include the enforcement of “bring your own device” policies for a corporate enterprise network, network penetration testing, network threat detection, and investigation, audit, and compliance.

Ease of operation and reduced cost is possible when the position identification of the trusted nodes is fully automated to simplify and increase the efficiency of network operations and task management. Automatic detection of the location of a device, and its association with a particular customer and/or client owner, provides the potential for fully automatic configuration of devices. Autonomous connection and configuration minimizes the work involved for any installer placing remote devices, or sensor nodes. This also minimizes possible errors that can occur.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates an embodiment of a network configuration instantiation of the present teaching.

FIG. 2 illustrates a flow chart of one embodiment of a method of reflective network device position identification according to the present teaching.

FIG. 3 illustrates a sequence diagram of an embodiment of a method of reflective device positioning according to the present teaching.

FIG. 4 illustrates a software and hardware module block diagram of an embodiment of a method according to the present teaching.

FIG. 5 illustrates an ecosystem of services in an embodiment of a system that uses the reflective device positioning method according to the present teaching.

FIG. 6 illustrates a block diagram of an apparatus comprising hardware and software modules that implement the method according to the present teaching.

### DESCRIPTION OF VARIOUS EMBODIMENTS

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings can be performed in any order and/or simultaneously as long as the teaching remains operable. Furthermore, it should be understood that the apparatus and methods of the present teachings can include any number or all of the described embodiments as long as the teaching remains operable.

Network location information about trusted devices is essential when a group of specialized trusted nodes or devices or sensors is distributed across a local area network (LAN), wide-area network (WAN), and/or the Internet, and are engaged in a collective distributed task by exchanging information with a trusted server. Determining the network domain location of a device is particularly important to enable those devices to participate in a collective task that spans a group of domains. In order to locate trusted devices efficiently, it is typically necessary to discover whether two or more such devices are located in a specific private network segment or domain. Then, it is necessary to establish the identity of those trusted devices, such that a common holistic view of the various network segments can be distributed to all the trusted devices participating in the collective task. Examples of collective tasks include performing a network security scan, performing network intrusion detection, and providing other node and network management and security functions. Other tasks include the enforcement of “bring your own device” policies for a corporate enterprise network, network penetration testing, network threat detection, and investigation and audit and compliance.

In order to maintain the integrity and security of the network domain location mechanism, it is necessary for the network positioning process to avoid exchanging information with other untrusted devices in that same network domain. Furthermore, it is desirable to not perform any kind of specialized discovery actions, such as broadcasts or other flood-based messaging, that can be detected and/or obstructed by malicious agents. Consequently, a mechanism is needed to identify whether two or more devices exist on a common private network using a trusted third party sharing little or no information with untrusted devices on the same network. The trusted third party device that orchestrates the distributed collective tasks is typically located at a remote offsite location from the network segments or domains in which the trusted devices are located. The trusted third party is frequently an endpoint server device that instantiates a network of trusted devices that are located in various network segments or domains. These various network segments or domains maybe different from that of the endpoint server device. The endpoint server device is then able to establish and coordinate operation of the trusted devices to perform various collective distributed tasks.

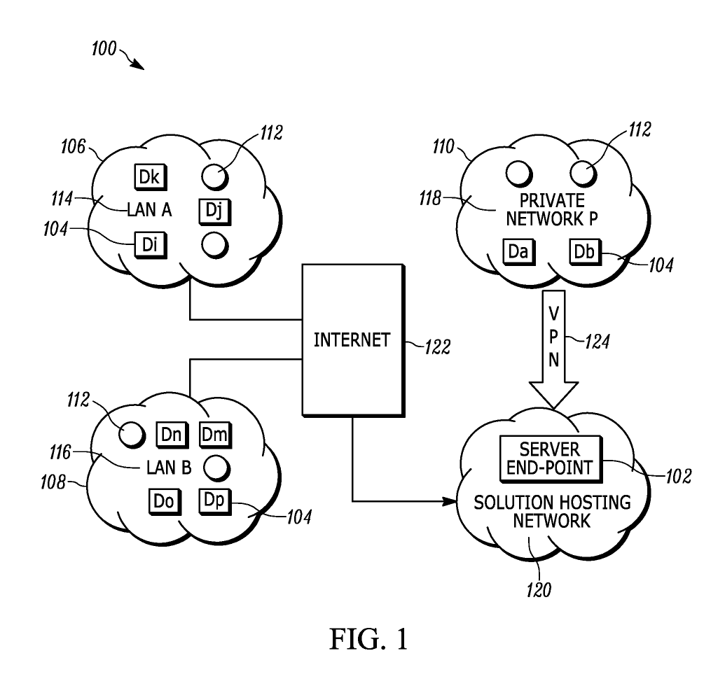

FIG. 1 illustrates an embodiment of a network configuration 100 instantiation of the present teaching. The network configuration 100 comprises an endpoint server 102 connected to one or more trusted devices 104 that are deployed in various network domains 106, 108, and 110. The various network domains 106, 108, and 110 also comprise various untrusted devices 112, shown as circles in FIG. 1. In the embodiment of FIG. 1, the various network domains 106, 108, and 110 with trusted network devices 112 include two local area networks, LAN A 114 (in domain 106), and LAN B 116 (in domain 108), and private network P 118 (in domain 110). The endpoint server 102 is located in solution hosting network segment H 120.

While the network configuration shown in FIG. 1 illustrates that the endpoint server 102 is a single device, it is well-known that the endpoint server's function can also be performed by a distributed network of servers. The endpoint server 102 can be located at a secure offsite location. The endpoint server 102 can also be located at any remote location, including a cloud. The terms “cloud”, and “cloud networking” as used herein includes services and networks that run over the public internet and work over any physical communications infrastructure, including wired or wireless infrastructures. The term “cloud” as used herein also includes so-called “private clouds” networking and services that run similarly over a private or proprietary infrastructure. The endpoint server 102 can also be located at one of the onsite networks where one or more trusted network devices 112 reside.

In the embodiment illustrated in FIG. 1, LAN A 114 and LAN B 116 are connected to the host network H 120 via the Internet 122. The private network P 118 is connected to the host network H 120 via a virtual private network VPN tunnel 124. The connections of the trusted devices 104 to their various network domains 106, 108, and 110 can be a wired connection, a wireless connection, or a combination thereof. One skilled in the art will appreciate that there are many variations of the network configuration shown in FIG. 1. In various embodiments, the trusted devices 104 are located in any variety of known network domain types that are connected to the host network H 120 via any variety of network connections, including public and private connections, secure and unsecure connections, and/or overt and covert connections.

It should be understood that the trusted devices 104 described herein can be also be referred as nodes, clients, and/or sensors. The trusted devices 104 may be part of the existing network infrastructure of the network in which they are located, or they may be placed, overtly or covertly, inside the network by an installer. In some embodiments, the trusted devices 104 are existing network devices that install new software code that runs protocols that implement the reflective network device method.

The trusted devices 104 may include any of a variety of networked devices including network nodes, such as switches and routers, wireless routers, computer processor and storage devices, such as clients, servers, tablets, laptops and other specialized processors, such as gaming devices, video servers, security appliances, and communication devices, such as cell phones and smart phones. The trusted devices may also be small form factor pluggable devices that may be placed covertly on a local network. The trusted devices may perform several functions, including one-click Evil AP and Passive Recon services, persistent reverse-SSH access to the target network, six unique covert channels for remote access through application-aware firewalls and IPS, support for HTTP proxies, SSH-VPN, OpenVPN, out-of-band SSH access over 4G/GSM cell networks, and wired NAC/802.1x/RADIUS bypass capability. The trusted device may be unpingable with no listening ports. Thus, the trusted device may operate in a stealth mode. The trusted devices may also provide local console access via HDMI.

In some embodiments, the trusted devices 104 are smart phones that include an external high-gain 802.11b/g/n wireless supporting packet injection & monitor mode. Also, in some embodiments, the trusted devices 104 are smart phones that include an external high-gain Bluetooth supporting packet injection (up to 1000′). Also, in some embodiments, the trusted devices 104 include an external USB-Ethernet adapter for wired network penetration testing. The smart phones may provide a custom Android front-end with penetration testing apps, such as Evil AP, Strings Watch, Full-Packet Capture, Bluetooth Scan, and SSL Strip. The smart phones may also utilize a custom Kali Linux back-end with comprehensive penetration testing suite, such as Metasploit, SET, Kismet, Aircrack-NG, SSLstrip, Ettercap-NG, Bluelog, Wifite, Reaver, MDK3, and FreeRADIUS-WPE. Also, the smart phones may provide one-touch update for a software toolkit. Also, the smart phones may provide multiple different covert channels to tunnel through application-aware firewalls & IPS. In addition, the smart phones may be unlocked 4G/LTE GSM (SIM card not included) and include USB OTG cable (for USB host-mode).

The trusted devices 104 may utilize wireless or wired connections to their respective local network infrastructure, LAN A 114, LAN B 116 or private network P 118. In some embodiments, a trusted device 104 of the system can connect to the Internet 122 via an Ethernet connection to the target network. In other embodiments, a trusted device 104 is capable of connecting to the Internet 122 via a wireless adapter connected to the device. In addition, the trusted device 104 can be capable of connecting to the Internet 122 via a cellular network adapter connected to the device. For example, the trusted device 104 can establish out-of-band SSH access over the cellular network.

It should also be understood that the network domains described herein are groups of connected devices on a network that are administered as a unit. The administration may be for purposes of management and/or security. Within the Internet, domains are defined by the IP address. All devices sharing a common part of the IP address are within the same domain. It is well known in the art that other network attributes, including various device identification means, may also be used to define a particular network domain. A network domain boundary may also be defined by one or more firewalls that restrict access to the domain. Once a domain boundary is defined, by whatever means and, for whatever purpose, the method of the present teaching provides a way to determine the domain in which a particular device is located, and more particularly, whether two devices are located within the same domain. The term network segment may also be used to represent a set of devices that belong to the same group or domain.

Known approaches to network device location and identification required looking exclusively at local and external addresses for comparison and determination of the domain location of a particular device. Due to the nature and complexity of existing networks, external addresses may be shared by potentially thousands of devices and internal network segments could overlap without issue, creating ambiguity in the device domain location. These prior approaches are thus not scalable, and they could not begin to isolate neighboring private networks.

Some methods of the present teaching identify the intermediary devices, and possible network routes, to multiple remote end points of the network. These methods also identify the intermediary devices, and possible network routes, in return from those endpoints. This approach minimizes or at least greatly reduces the possible errors when comparing device locations. Using this method can additionally identify clients on “neighboring” networks, in which they share a private router but are effectively within the same communication domain.

One feature of the method of the present teaching is the use of graph metric methods that determine the location of devices that are deployed in a plurality of network domains. In some embodiments, these devices are trusted devices that autonomously connect both to the local network domain in which they are located, and, also autonomously, and in some cases covertly, connect to a remotely located endpoint server device.

One feature of the method of the present teaching is that the trusted devices 104 generate graph representations of their local domain using various known techniques. The trusted devices 104 probe their local network environment by participating in various communication protocols. It is well known that connected devices exchange information in routine network operation. Attributes about the untrusted devices 112 may be derived based on responses to various network probes sent by the trusted device. The local network graphs generated by the trusted devices 104 comprise nodes and edges that include the attributes that are accumulated and organized into a graph representation by the trusted device.

Various graph metric methodologies have been previously used to establish network robustness (see, for example, http://individual.utoronto.ca/ali_tizghadam/simplex.pdf, http://www.dynamic-connectome.org/pubs/Ribeiro2009IEEE.pdf). The methods of the present teaching apply these and other graph metric methods to determine the presence of multiple network security devices in the same network segment optimally, and in some cases, undetectably. For example, some embodiments of the present teaching use a graph comparison mechanism of graphs derived from multiple trace routes performed by multiple network security devices to determine whether or not these network security devices are located in the same network segment.

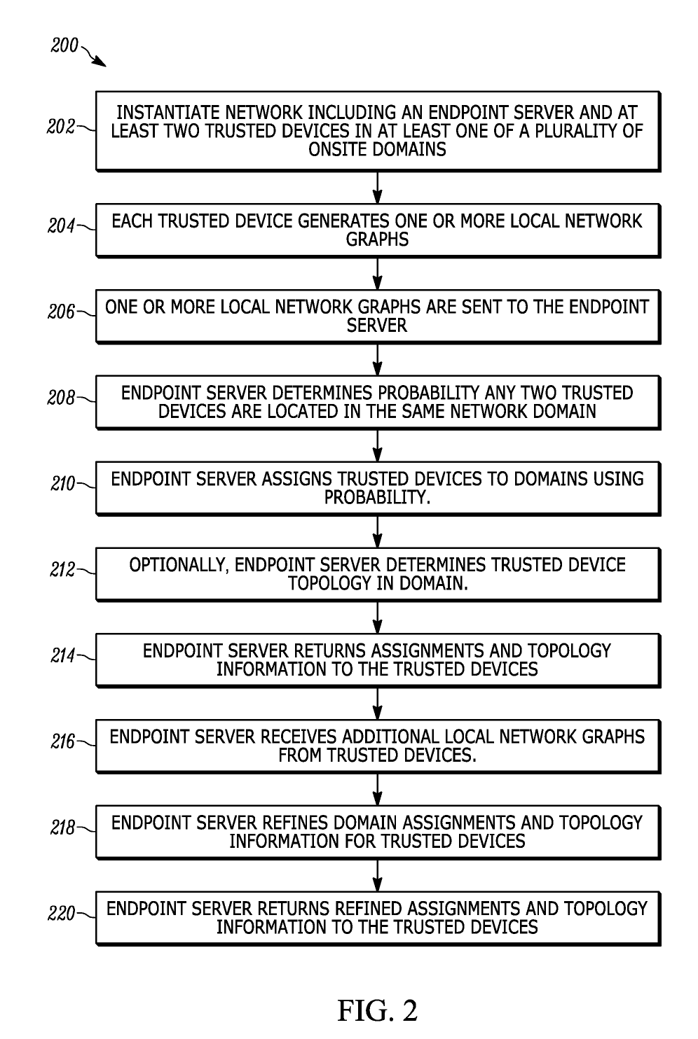

FIG. 2 illustrates a flow chart 200 of one embodiment of a method of reflective network device position identification according to the present teaching. In the first step 202 of the method, a network is instantiated amongst the trusted devices and endpoint server by initiating communication channels from the trusted devices to the endpoint server, and, optionally, amongst the trusted devices. An endpoint server as described herein is a server that has formed a connection with one or more trusted devices. Not all trusted devices are required to make a connection to the endpoint server.

In step two 204 of the method of reflective network device position identification of the present teaching, each trusted device generates multiple local network graphs. In some methods, the multiple local network graphs are generated by having each trusted device performs an ICMP, TCP, and UDP traceroute multiple times against each configured server in their surrounding networks. The traceroute command provides the path a packet of information uses between two specified endpoint devices across an Internet Protocol (IP) network. Traceroute returns a list of routers traversed to the destination, or those traversed until the packet fails to reach the destination and is discarded. Thus, the traceroute provides information about network infrastructure and IP ranges around a given device. Traceroute collects not only the route, or path, but also measured transit delays of packets. It provides the list of traversed routers in a simple text format, together with timestamp information for each node traversed. Each trusted device records the results of the multiple traceroutes in one or more graphs that represent the possible paths packets could take to a given a server in proximity to the trusted device. In some embodiments, the local network graphs generated by the trusted devices comprise these traceroute path graphs.

In step three 206 of the method 200, the multiple local network graphs are sent to the endpoint server. In step four 208 of the method 200, the endpoint server determines the probability that any two trusted devices are located in the same domain by performing processing on the received local network graphs. In some embodiments, the determination of the probability that any two trusted devices are located in the same domain follows a statistical averaging approach for graph equivalence using a probability threshold. Each generated local network graph includes the publicly routable IP addresses of the traceroute. A collection of IP routing address prefixes under the control of one or more network operators on behalf of a single administrative entity or domain is known as an autonomous system (AS). The endpoint server aggregates the publicly routable IP addresses within each local network graph based on which AS is associated with the prefixes of those addresses. The effect of multipath routing issues is limited by aggregating by the most specific route that particular AS is broadcasting.

The endpoint server compares the local network graphs of a pair of trusted devices for commonality by looking for where their traffic starts to share a common path and a common router. Trusted device pairs that are closest to a first shared router receive the highest probability that they are in the same domain address space. The probability determined relates generally to the distance of the trusted devices to the first shared router. The farther away trusted devices are to the first shared router, the lower the probability.

The local network graphs are also compared for commonality by looking for where their traffic starts to share a common path. The closest the first shared router is to each client, the higher the resulting probability is that they are in the same domain address space. If the probability is above the acceptable threshold the clients are said to be on the same network and any associated information is returned to the clients.

In step five 210 of the method 200, the endpoint server assigns trusted devices to domains based on the determined probability. In optional step six 212 of the method 200, the endpoint server determines the topology of the various trusted devices in the instantiated network. In step seven 214 of the method 200, the information is sent back to the trusted devices. In step eight 216 of the method 200, the endpoint server may also receive additional local network graphs from the trusted devices.

In optional step nine 218 of the method 200, the endpoint server further refines the method of determining probability or results of the previous probability determinations from step four 208. This step includes performing the steps of assignment or results of the previous assignments in step five 210, and the steps of topology determination or results of the topology of the previous topology determination in step six 212. In step ten 220 of the method 200, the endpoint server sends these new results to the trusted devices.

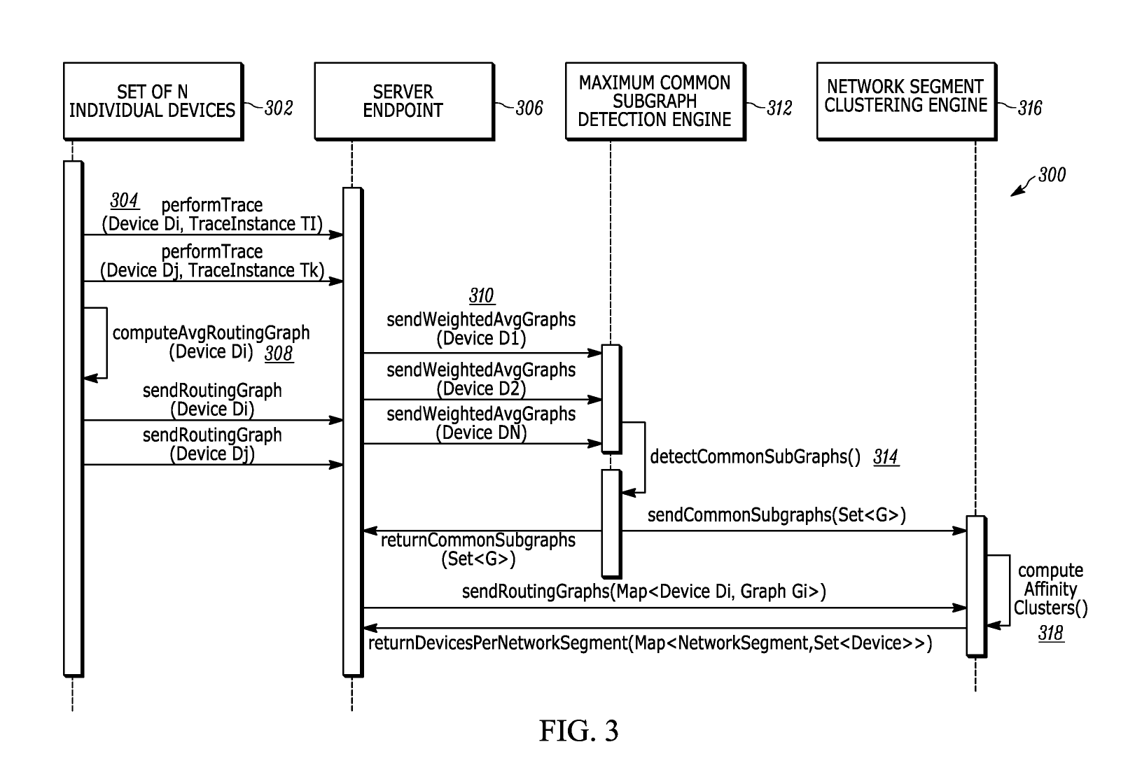

FIG. 3 illustrates a sequence diagram 300 of an embodiment of a method of reflective device positioning according to the present teaching. The trusted devices 302 generate traceroutes 304 and send them to the endpoint server 306. In this embodiment, the trusted devices 302 additionally compute an average routing graph 308 from the multiple traceroutes. The average routing graph 308 is the computation of the average shortest path route graph from the multiple traceroutes of a single trusted device 302.

In some embodiments, the local network graphs are results of the multiple traceroutes of the trusted devices 302, and are sent to the endpoint server 306. In some embodiments, the average routing graphs 308 from each trusted device 302 that computes an average routing graph 308 is sent to the endpoint server 306. Multiple local network graphs from different trusted devices 302 are sent to the endpoint server 306.

As shown in the sequence diagram of FIG. 3, the endpoint server 306 may additionally comprise one or more processing engines. The endpoint server 306 may generate weighted average graphs 310 using the average routing graphs 308 that were sent by the trusted devices 302. The weighted average graphs 310 are sent to a maximum common subgraph detection engine 312 that detects common subgraphs 314 between average routing graphs 308 from pairs of trusted devices 302. The maximum common subgraphs detections engine 312 sends the common subgraphs 314 to a network segment clustering engine 316. The maximum common subgraph detection engine 312 also returns the common subgraphs 314 to the endpoint server 306.

The network segment clustering engine 316 computes affinity clusters 318 and returns device network segment information back to the endpoint server 306. The endpoint server 306 may then send the common subgraph information and assignment information back to the trusted devices 302.

One feature of the present teaching is the use of self-evolution and/or learning in the processing steps to improve performance. In some embodiments, the endpoint server 306 determines the probabilities that two trusted devices 302 are located in the same domain based on a heuristic-driven self-evolution of the comparison mechanism. In some methods, the probability calculation is associated with largest matching subgraphs between the two devices' routing graphs.

In the ideal situation with probability equal to one that the trusted nodes are in the same domain, the largest matching subgraphs would be the routing graphs themselves which would be isomorphic to each other. For all other probabilities, there may or may not be found matching subgraphs. In the case where matching subgraphs are found, the structure of the largest matching subgraph found is stored as a 2-D matrix and associated with the corresponding probability. In the ideal situation, the probability computation algorithm would be a monotonic function of the largest matching subgraphs. That is, the probability of a match should increase as the size of the largest matching subgraph increases. However, in an observed data set across a large collection of such private network segments this may not occur in practice.

In some methods according to the present teaching, the probability computation algorithm itself is evolved to better represent the likelihood of matching. In one embodiment, the probability computation algorithm uses a weighted average over the shortest path edges between the common nodes in the two local network graphs of the trusted nodes being compared. The endpoint server continuously tunes the weights used in the weighted average across a large and growing data set of such sets of local network graphs arriving from various private networks. Additionally, in some embodiments, the weighted average is also further refined whenever a false positive is recognized as a result of the domain assignment and refinement in later steps of the method of the present teaching.

In some embodiments of the method of the present teaching, the endpoint server first finds the maximum common subgraph (MCS) between the local network graphs for a pair of trusted devices. The endpoint server then establishes whether the maximum common subgraph contributes sufficiently to the two parent routing graphs (i.e., the local network graphs for the pair of trusted devices) to render them sufficiently similar in the context of network segment affinity. In other words, the endpoint server establishes whether the probability is high that the two trusted devices are located in the same network domain or segment. Finding the MCS is a NP-hard problem. A problem is called an NP-problem (nondeterministic polynomial-time) if it is solvable in polynomial time by a nondeterministic Turing machine. A problem is said to be NP-hard if an algorithm for solving it can be translated into one for solving any other NP-problem. NP-hard problems are thus at least as hard to solve as any NP-problem. There are various standard methods commonly used to address NP-hard problems optimally that can be used to establish the network segment affinity for the two devices in purely a statistical nature.

In some methods according to the present teaching, a maximum common subgraph detection engine receives N routing graphs G1 . . . GN for N different trusted devices, D₁ . . . D_{N}. All Gs are directed acyclic graphs where the nodes (router's hops) in each graph are uniquely identifiable by their device though a MAC address and/or local internet address (IP). The statistical-probabilistic algorithm first detects all the common nodes between any two graphs in that set. The outcome hence is a two-dimensional array Nᵢⱼ where i=1 . . . N; j=1 . . . N, and where each Nᵢⱼ element is a set of Nodes. Each Nᵢⱼ is evidently a subset of nodes in Gᵢ or Gⱼ. In the perfect match scenario Nᵢⱼ matches exactly with the nodes in Gᵢ as well as Gⱼ. In such a scenario, even if there is divergence in terms of directionality or edge orientation, we can conclude that Dᵢ and Dⱼ are in the same local network segment.

Array Nᵢⱼ is a subset of both Nodes(G) and Nodes(G). The method of the present teaching thus first determines how much of a factor the difference between (Nodes(Gᵢ)−Nᵢⱼ) and (Nodes(Gⱼ)−Nᵢⱼ) is to identify two devices as belonging to essentially different network segments.

The graph commonality is a greater determining factor in network segment affinity than the graph difference. That is, if the local network graph for two devices possess a sufficiently similar routing graph for majority of its traces, then they are likely to be in a similar network segment despite any significant differences in those occasions when the routing graphs are different. In this situation, each Gᵢ is already a weighted graph where each edge (Gᵢ)kₗ between two nodes K and L in a Gᵢ indicates the number of times that particular path was traversed. Hence, a good measure of the similarity of Gᵢ and Gⱼ is how much of the subgraph comprising Nᵢⱼ contributes to the overall weight of the Gᵢ and Gⱼ. That is, (Gᵢ−Subgraph(Nᵢ))−(Gⱼ−Subgraph(Nᵢⱼ)) is immaterial compared to the individual values of (Gᵢ−Subgraph(Nᵢⱼ)) and (Gⱼ−Subgraph(Nᵢⱼ)).

In some embodiments, the MCS detection uses a Durand-Pasari algorithm. This algorithm is based on the well known reduction of the search of the MCS between two graphs to the problem of finding a maximum cycle in an association graph. The first step of the algorithm is the construction of the association graph. The nodes of the association graph correspond to pair of nodes of the two starting graphs that have the same label. The edges of the association graph represent the compatibility of the pair of nodes that correspond to the association graph node. The MCS is obtained by finding the maximum cycle in the association graph.

The algorithm for maximum cycle detection generates a list of association graph nodes that represents a clique of the association graph using a depth-first search strategy on a search tree. This is achieved by systematically selecting one node at a time from successive levels until it is not possible to add further nodes to the list. Various embodiments of MCS and cycle detection of the current teaching use other algorithms known in the art, for example, some embodiments rely on algorithms that are based on state space representation.

Once the MCS G(Nᵢⱼ) has been identified, the problem becomes to determine whether G(Nᵢⱼ) is sufficiently close to Gᵢ and Gⱼ to decide if Gᵢ and Gⱼ represent same local network segment. Knowing that Gᵢ, Gⱼ and G(Nᵢⱼ) are all weighted graphs where the weights identify how frequently an edge (a hop) is traveled, the probability that G(Nᵢⱼ) is close to Gᵢ in the context of network segment identification can simply be measured by summing the weights of the edges of the corresponding graphs and computing their ratio. These summed weights over all edges are referred to herein as Wᵢ, Wⱼ and Wᵢⱼ respectively. Then the conditional probabilities that the devices are in the same domain become Pᵢ(ij)=Wᵢⱼ/Wᵢ and Pⱼ(ij)=Wᵢⱼ/Wⱼ. The domain assignment problem now becomes identifying the correct threshold range for Pᵢ(ij) and Pj(ij) such that Gi and Gj are determined to be similar enough route graphs to confirm Dᵢ and Dⱼ are in the same network segment.

However, it is worth noting that the likelihood the Pᵢ(ij) and Pⱼ(ij) represent same network segment is dependent on the shape of the Gᵢ and Gⱼ themselves. That is, the optimal range for positive decision for Pᵢ(ij) and Pⱼ(ij) are dependent on the shape of Gᵢ and Gⱼ. Thus, some embodiments of the method of the present teaching use multiple classifications for each of these ranges, such as: (1) definitely same network segment; (2) most likely same network segment; (3) most likely not the same network segment; (4) not at all the same network segment.

In some embodiments according to the present teaching, unsupervised Bayesian learning is used to perform predictions on the classification determination. In these embodiments, once a decision on device location based on an initial probability distribution has been identified and the devices are classified according to their network segments, subsequent confirmatory identifications are used to further change the probability ranges associated with the each class.

One skilled in the art will appreciate that the precise heuristics technique and/or algorithm employed to improve a statistical graph comparison mechanism is not limited to the above description. In various embodiments, various known heuristics techniques and/or algorithms may be applied.

One feature of the method of reflective network device position identification of the present teaching is that the domain assignments may be established using various classifications and probability ranges. In some methods of the present teaching, the endpoint server assigns trusted devices to domains based on the determined probability. In some methods, if the determined probability is above a predetermined acceptable threshold, the trusted devices are said to be on the same network or domain. In other method, the assignment of trusted devices to domains is based upon the determined probability falling into a predetermined probability range. The predetermined ranges are later modified, or re-determined, based on the previously assigned domains.

One feature of the reflective device positioning method of the present teaching is that it is possible to determine a topology for the trusted devices in the instantiated network. The endpoint server determines the topology of the trusted nodes based on the local network graphs. The topology may extend across multiple domains.

In some methods, the trusted devices provide additional updates of the local network graphs, and/or verifications of domain assignments to the endpoint server. These updates may include new traceroutes, and new averaged local network graphs. The endpoint server receives additional local network graphs from the trusted device. The endpoint server uses the additional local network graphs to create new and/or refine old probabilities that the trusted nodes are located in the same domain. That is, the endpoint server re-determines the probabilities based on the additional local network graphs. The endpoint server can refine assignment probability thresholds or ranges based on the new information. The endpoint server can also refine the domain assignments of trusted nodes based on the new information. The endpoint server can also refine the topology of the trusted nodes based on the new information. In addition, the endpoint server can return the new domain assignments and topology information to the trusted nodes.

In some embodiments, the location of the devices, and their common assignment to a particular network or domain, together with any associated information, is returned to the trusted devices in later steps of the method. This assignment and other information can be used to generate the local network graphs, and also can be used to determine if the assignment is correct. Additionally, in some embodiments of the present teaching, the endpoint server re-determines probabilities that at least some of the plurality of trusted devices are positioned in the same domain as the plurality of local network graphs, reassigns trusted devices to domains based upon the re-determined probabilities, and updates domain assignments for at least some of the plurality of trusted devices based upon the reassignments whenever a false positive is recognized as a result of the domain assignment and refinement steps of the method.

In some embodiments, the method of the present teaching is performed by various software modules associated with an application executing on a common server platform that performs remote network management and various security functions including remote penetration testing.

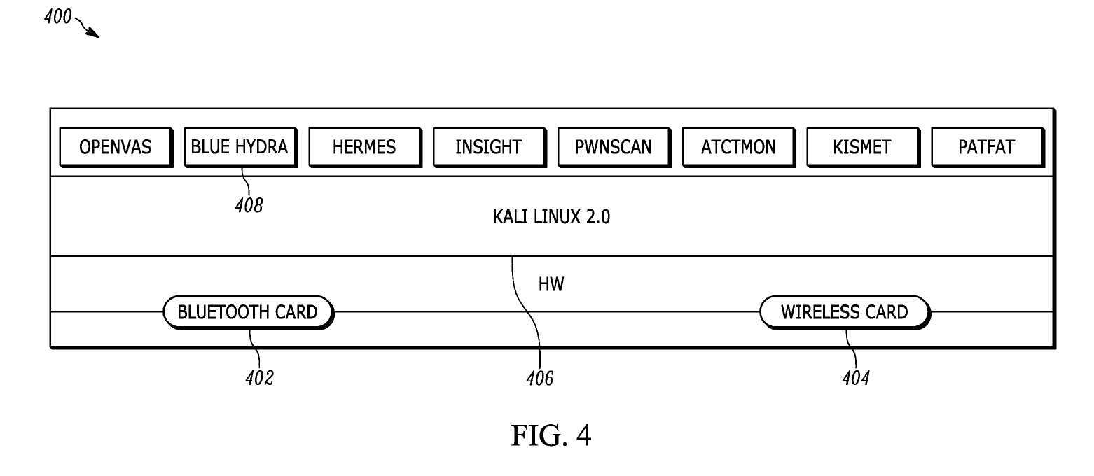

FIG. 4 illustrates a software and hardware module block diagram of an embodiment of a security appliance 400 according to the present teaching. The security appliance comprises hardware and software that perform networking and communication functions and sensing functions of the network to which it is attach. As shown in FIG. 4, the platform hardware on a trusted device includes a Bluetooth card 402, wired interface (not shown) and wireless network interface cards 404. The trusted nodes establish one or more connections to the onsite network, which can be a LAN or other private network, using the network interfaces 402, 404. The trusted nodes run Linux software operating system 406. In some embodiments, the various hardware and software modules provides more than one hundred OSS-based penetration testing tools, such as Metasploit, SET, Kismet, Aircrack-NG, SSLstrip, Nmap, Hydra, W3af, Scapy, Ettercap, and Bluetooth/VoIP/IPv6tools.

Various software application modules 408 execute on the Linux operating system 406, allowing the security appliance to perform various functions. The various functions performed by the software application module include detection and viewing of trusted and untrusted devices on the network. This function continuously discovers in real time all wired, WiFi, and Bluetooth devices in the vicinity of a network domain or domains. Another function is identifying, fingerprinting, auditing and logging devices in a network domain or domains. This function provides a comprehensive list of devices, behaviors and/or historical information that can help recognize noncompliant, misconfigured, unauthorized or threatening devices. Another function performed by the software application modules is monitoring and alerting based on established network security policies using a rules library. This function provides customizable continuous device monitoring to determine changes, misconfigurations, and/or security policy violations, and provides alerts back to a management system regarding those changes. Another function performed by the software application module is to respond and report based on security policies. This function tracks and disables devices on a network domain or domains. Another function is identification of rogue devices on a network domain or domains. The rogue devices include wireless keyloggers, rogue (evil) access points, WiFi and Bluetooth hacking gear, hacking and penetration testing drop boxes, mobile hacking gear, and wireless card skimmers.

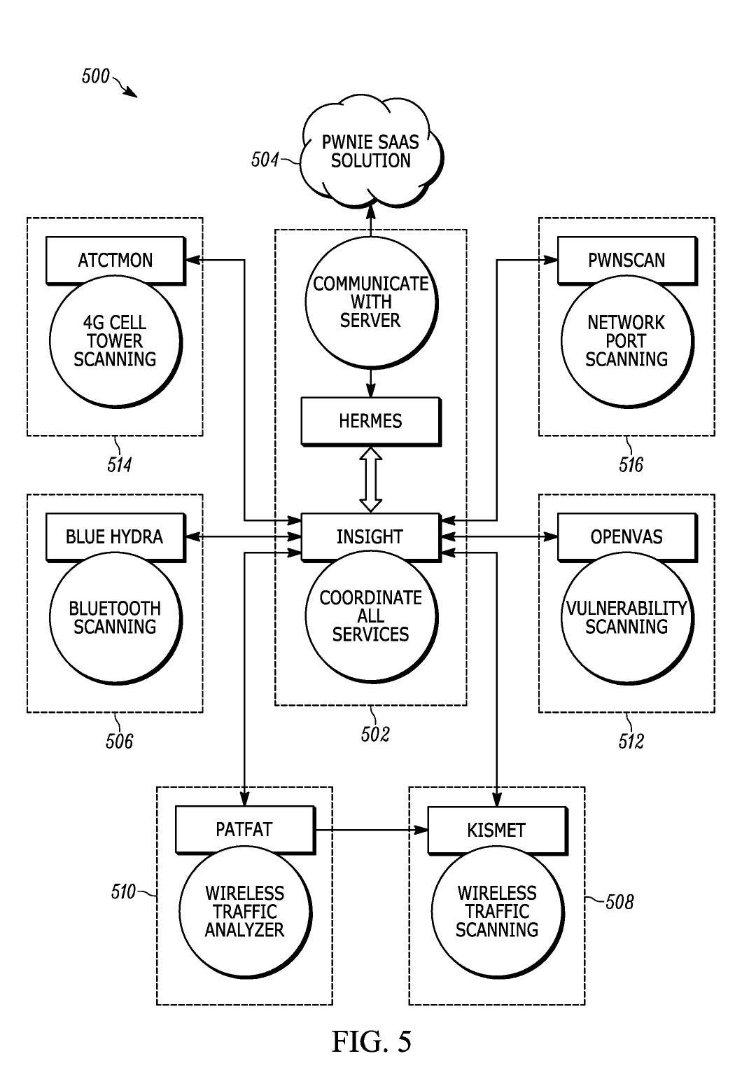

FIG. 5 illustrates an ecosystem of services 500 in an embodiment of a system that uses the reflective device positioning method according to the present teaching. FIG. 5 illustrates how the various application modules connect to perform various functions. In some embodiments, the software that implements the method of the present teaching in the trusted node resides in the communication and coordination module 502. The software that implements the method of the present teaching in the endpoint server resides in a module at an offsite location or in the cloud 504. In some embodiments, an endpoint server in the cloud 504 assigns domains to various trusted nodes, and these domain assignments are communicated to the trusted nodes using the communication and coordination modules 502 in each trusted node. The domain assignments are then used by the communication and coordination modules 502 to control and manage various other functions performed by the trusted node, including Bluetooth scanning 506, wireless traffic scanning 508, wireless traffic analysis 510, vulnerability scanning 512, 4G cell tower scanning 514, and network port scanning 516. The communication and coordination module 502 may also be used to refine the local network graphs for communication back to the endpoint server. The communication between the communication and coordination module 502 and the endpoint server in the cloud 504, may reside on a covert and encrypted channel that is established by the trusted node to the endpoint server using an encrypted back door that is part of the communication and coordination module 502.

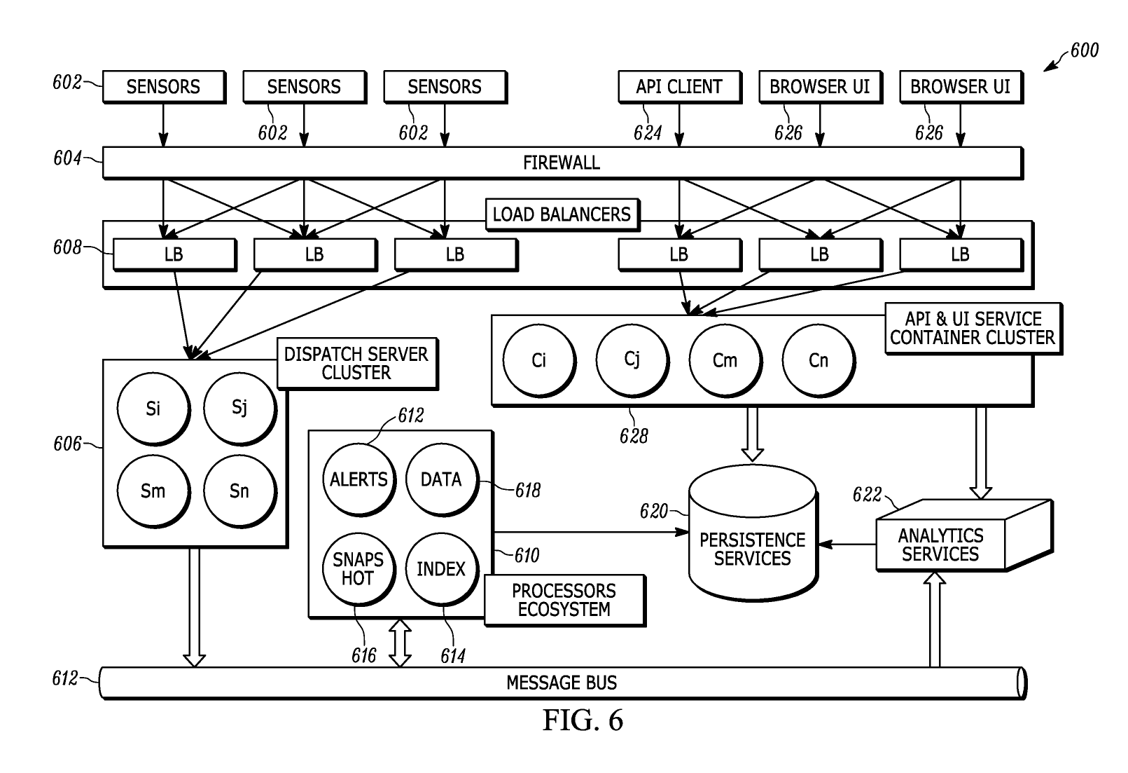

FIG. 6 illustrates a block diagram of an apparatus 600 comprising hardware and software modules that implement the method according to the present teaching. Trusted devices, or sensors 602, are located behind a firewall 604 in a network domain. The sensors 602 initiate a connection to an endpoint server. In this embodiment, the endpoint server is a cluster of servers called the dispatch server cluster 606. Load balancers 608 act as a reverse proxy and also distribute the communications from the sensors 602 across a number of servers in the dispatch server cluster 606. The dispatch server cluster 606 connects to a processor ecosystem 610 via a message bus 612. The processor ecosystem 610 provides alerts 612, indexing 614, snapshots 616 and data 618. The functions provided by the processor ecosystem 610 are informed by data provided about the network domain behind the firewall 604 by the sensors 602 via the dispatch server cluster 606. Data provided about the network domain behind the firewall 604 provided by the sensors 602 thus contributes to persistence services 620, and analytics services 622. These services are accessed by users or clients that own the network domain via an API client 624, and various browser UI 626 that connect to an API and UI service container cluster 628 that is connected to the persistence services 620 and analytics services 622. In this way, the users or clients advantageously probe and monitor the status and security of their network domain.

Thus, the apparatus 600 of FIG. 6 provides simple and scalable asset discovery, vulnerability scanning and penetration testing solutions for remote sites and all wired and wireless networks and devices in a client network domain. The apparatus and method of the present teaching may also be extended to clients and users with multiple network domains.

Using heuristic-based approaches for the method of reflective network device position identification of the present teaching advantageously provides continuous improvement of the outcomes and refinement of the algorithms used for the identification based on collected information. Any of a number of known heuristic techniques and/or algorithms may be used to improve the statistical graph comparison mechanism, the probability assignment process, and the fidelity of the domain assignment.

### EQUIVALENTS

While the Applicant's teaching is described in conjunction with various embodiments, it is not intended that the Applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A method of identifying a trusted device positioned in a network and making domain assignments, the method comprising:
a) receiving at a server a plurality of local network graphs from at least some of a plurality of trusted devices positioned in at least two different domains;
b) determining a probability that at least some of the plurality of trusted devices are positioned in the same domain from the plurality of local network graphs;
c) assigning trusted devices to domains based upon the determined probabilities; and
d) updating domain assignments for at least some of the plurality of trusted devices based upon the assignments of trusted devices to the domains.

2. The method of identifying the trusted device positioned in the network and making domain assignments of claim 1 further comprising instantiating a network comprising the server and the plurality of trusted devices positioned in at least two different domains.

3. The method of identifying the trusted device positioned in the network and making domain assignments of claim 1 wherein the server comprises an offsite server.

4. The method of identifying the trusted device positioned in the network and making domain assignments of claim 1 wherein at least some of the plurality of trusted devices comprise security appliances.

5. The method of identifying the trusted device positioned in the network and making domain assignments of claim 1 wherein a respective one of the plurality of local network graphs comprise edges and nodes that represent paths of packets from a respective one of the plurality of trusted devices to a configured server.

6. The method of identifying the trusted device positioned in the network and making domain assignments of claim 1 further comprising generating the plurality of local network graphs from at least some of the plurality of trusted devices positioned in at least two different domains.

7. The method of identifying the trusted device positioned in the network and making domain assignments of claim 6 wherein the generating the plurality of local network graphs for at least some of the plurality of trusted devices positioned in at least two different domains comprises generating local network graphs for each of the plurality of trusted devices positioned in the at least two different domains.

8. The method of identifying the trusted device positioned in the network and making domain assignments of claim 6 wherein the generating the plurality of local network graphs comprises autonomously generating the plurality of local network graphs.

9. The method of identifying the trusted device positioned in the network and making domain assignments of claim 6 wherein the generating the plurality of local network graphs comprises performing a plurality of traceroutes to a configured server.

10. The method of identifying the device positioned in the network and making domain assignments of claim 9 wherein the performing the plurality of traceroutes to the configured server comprises performing the plurality of traceroutes against each configured server end point.

11. The method of identifying the trusted device positioned in the network and making domain assignments of claim 10 wherein the generating the plurality of local network graphs further comprises generating a plurality of graphs representing possible paths to the configured server derived from the plurality of traceroutes against each configured server end point.

12. The method of identifying the trusted device positioned in the network and making domain assignments of claim 9 wherein the traceroute to the configured server is selected from a group consisting of an ICMP traceroute, a TCP traceroute, and a UDP traceroute.

13. The method of identifying the trusted device positioned in the network and making domain assignments of claim 6 wherein at least some of the plurality of trusted devices generate at least some of the plurality of local network graphs.

14. The method of identifying the trusted device positioned in the network and making domain assignments of claim 1 wherein the server comprises an offsite server.

15. The method of identifying the trusted device positioned in the network and making domain assignments of claim 1 wherein the determining the probabilities that at least some of the plurality of trusted devices are positioned in the same domain from the plurality of local network graphs comprises performing a weighted average over shortest path edges in the plurality of local network graphs.

16. The method of identifying the trusted device positioned in the network and making domain assignments of claim 1 wherein the determining probabilities that at least some of the plurality of trusted devices are positioned in the same domain from the plurality of local network graphs comprises continuously tuning weights based on additional network graphs.

17. The method of identifying the trusted device positioned in the network and making domain assignments of claim 1 wherein the determining probabilities that at least some of the plurality of trusted devices are positioned in the same domain from the plurality of local network graphs comprises comparing a number of common paths in the plurality of local network graphs.

18. The method of identifying the trusted device positioned in the network and making domain assignments of claim 17 wherein the comparing the number of common paths in the plurality of local network graphs comprises performing a heuristic driven self-evolution.

19. The method of identifying the trusted device positioned in the network and making domain assignments of claim 1 wherein the assigning trusted devices to domains based upon the determined probabilities comprises assigning trusted devices to domains based upon predetermined probability ranges.

20. The method of identifying the trusted device positioned in the network and making domain assignments of claim 19 wherein the predetermined probability ranges are modified based on the domain assignments.

21. The method of identifying the trusted device positioned in the network and making domain assignments of claim 1 wherein the updating the domain assignments for at least some of the trusted devices comprises updating the domain assignments for each of the trusted devices.

22. The method of identifying the trusted device positioned in the network and making domain assignments of claim 1 further comprising determining if the domain assignment of the trusted device is incorrect and if so, re-determining probabilities that at least some of the plurality of trusted devices are positioned in the same domain from the plurality of local network graphs, reassigning trusted devices to domains based upon the re-determined probabilities, and updating domain assignments for at least some of the plurality of trusted devices based upon the reassignments.

23. The method of identifying the trusted device positioned in the network and making domain assignments of claim 1 further comprising determining trusted node topology in at least one of the at least two different domains.

24. The method of identifying the trusted device positioned in the network and making domain assignments of claim 23 wherein the determining the trusted node topology is performed with an offsite server.

25. The method of identifying the trusted device positioned in the network and making domain assignments of claim 23 further comprising determining trusted node topology for each of the at least two different domains.

26. The method of identifying the trusted device positioned in the network and making domain assignments of claim 25 further comprising updating the network topology based upon the assignment.

27. The method of identifying the trusted device positioned in the network and making domain assignments of claim 26 further comprising receiving additional local network graphs from at least one of the trusted devices before updating the network topology.

28. A method of identifying a trusted device positioned in a network and identifying a network topology, the method comprising:
a) receiving at a server a plurality of local network graphs for at least some of a plurality of trusted devices positioned in at least two different domains;
b) determining probabilities that at least some of the plurality of trusted devices are positioned in the same domain from the plurality of local network graphs;
c) assigning trusted devices to a network topology based upon the determined probabilities; and
d) updating the network topology for at least some of the plurality of trusted devices based upon the assignments of trusted devices to the network topology.

29. The method of identifying the trusted device positioned in the network and identifying the network topology of claim 28 wherein at least some of the plurality of trusted devices generate at least some of the plurality of local network graphs.

30. The method of identifying the trusted device positioned in the network and identifying the network topology of claim 28 wherein at least some of the plurality of trusted devices comprise a security appliance.

31. The method of identifying the trusted device positioned in the network and identifying the network topology of claim 28 wherein a respective one of the plurality of local network graphs comprise edges and nodes that represent paths of packets from a respective one of the plurality of trusted devices to a configured server.

32. The method of identifying the trusted device positioned in the network and identifying the network topology of claim 28 further comprising generating the plurality of local network graphs for at least some of the plurality of trusted devices positioned in the at least two different domains.

33. The method of identifying the trusted device positioned in the network and identifying the network topology of claim 32 wherein the generating the plurality of local network graphs for at least some of the plurality of trusted devices positioned in the at least two different domains comprises generating local network graphs for each of the plurality of trusted devices positioned in the at least two different domains.

34. The method of identifying the trusted device positioned in the network and identifying the network topology of claim 32 wherein the generating the plurality of local network graphs comprises autonomously generating the plurality of local network graphs.

35. The method of identifying the trusted device positioned in the network and identifying the network topology of claim 32 wherein the generating the plurality of local network graphs comprises performing a traceroute to a configured server.

36. The method of identifying the trusted device positioned in the network and identifying the network topology of claim 35 wherein the performing the traceroute to the configured server comprises performing a plurality of traceroutes against each configured server end point.

37. The method of identifying the trusted device positioned in the network and identifying the network topology of claim 36 wherein the generating the plurality of local network graphs further comprises generating a plurality of graphs representing possible paths to the configured server from the plurality of traceroutes against each configured server end point.

38. The method of identifying the trusted device positioned in the network and identifying the network topology of claim 37 wherein the traceroute to the configured server is selected from the group consisting of an ICMP traceroute, a TCP traceroute, and a UDP traceroute.

39. The method of identifying the trusted device positioned in the network and identifying the network topology of claim 28 wherein the server comprises an offsite server.

40. The method of identifying the trusted device positioned in the network and identifying the network topology of claim 28 wherein the determining probabilities that at least some of the plurality of trusted devices are positioned in the same domain from the plurality of local network graphs comprises performing a weighted average over the shortest path edges in the plurality of local network graphs.

41. The method of identifying the trusted device positioned in the network and identifying the network topology of claim 28 wherein the determining probabilities that at least some of the plurality of trusted devices are positioned in the same domain from the plurality of local network graphs comprises continuously tuning weights based on additional network graphs.

42. The method of identifying the trusted device positioned in the network and identifying the network topology of claim 28 wherein the determining probabilities that at least some of the plurality of trusted devices are positioned in the same domain from the plurality of local network graphs comprises comparing a number of common paths in the plurality of local network graphs.

43. The method of identifying the trusted device positioned in the network and identifying the network topology of claim 42 wherein the comparing the number of common paths in the plurality of local network graphs comprises performing a heuristic driven self-evolution.

44. The method of identifying the trusted device positioned in the network and identifying the network topology of claim 28 wherein the assigning trusted devices to the network topology based upon the determined probabilities comprises assigning trusted devices to the network topology based upon predetermined probability ranges.

45. The method of identifying the trusted device positioned in the network and identifying the network topology of claim 44 wherein the predetermined probability ranges are modified based on the network topology.

46. The method of identifying the trusted device positioned in the network and identifying the network topology of claim 28 wherein the updating the network topology for at least some of the trusted devices comprises updating the network topology for each of the trusted devices.

47. The method of identifying the trusted device positioned in the network and identifying the network topology of claim 28 further comprising determining if an assignment of the trusted device is incorrect and if so, re-determining probabilities that at least some of the plurality of trusted devices are positioned in the same domain from the plurality of local network graphs, reassigning trusted devices to domains based upon the re-determined probabilities, and updating network topology for at least some of the plurality of trusted devices based upon the reassignments.

48. The method of identifying the trusted device positioned in the network and identifying the network topology of claim 28 further comprising determining the trusted node topology in at least one of the at least two different domains.

49. The method of identifying the trusted device positioned in the network and identifying the network topology of claim 48 wherein the determining the trusted node topology is performed with an offsite server.

50. The method of identifying the trusted device positioned in the network and identifying the network topology of claim 48 further comprising determining the trusted node topology for each of the at least two different domains.

51. The method of identifying the trusted device positioned in the network and identifying the network topology of claim 28 further comprising updating the network topology based upon the assignment of the trusted device to the network topology.

52. The method of identifying the trusted device positioned in the network and identifying the network topology of claim 28 further comprising receiving additional local network graphs from at least one of the trusted devices before updating the network topology for the plurality of trusted devices.
